(19) United States
(12) Patent Application Publication
(10) Pub. No.: US 2003/0083023 A1
(43) Pub. Date: May 1, 2003

(54) Antenna device of wireless phone

(76) Inventors: Jun-Woo Chang, Seoul (KR); Wan-Ho Kim, Sungnam-si (KR); Sang-Won Lee, Sungnam-si (KR)

Correspondence Address: McGuireWoods LLP, Suite 1800, 1750 Tysons Boulevard, McLean, VA, 22102, US

(21) Appl. No.: 10/265,154

(22) Filed: Oct. 7, 2002

(30) Foreign Application Priority Data
Oct. 31, 2001 (KR) 2001-67446

(51) Int. Cl. H04B 1/38; H04M 1/00

(52) U.S. Cl. 455/90; 455/550; 455/575

(57) ABSTRACT

An antenna device of a wireless phone is disclosed, which can effectively adjust directions of a helical antenna and a rod antenna so as to minimize any effect of electronic waves on a human body. A fitting metal and a contact part of a rod antenna guide are spaced apart from each other at a predetermined distance or the rod antenna guide has an inner diameter enough to rotate the fitting metal at a predetermined angle. A connecting rod fixed to a main body case of a wireless phone is provided at both ends of the fitting metal fitted into a helical antenna, and the fitting metal is rotated at a predetermined angle around the connecting rod. The angle of the antennas is adjusted when a stopper of the rod antenna is in contact with the helical antenna as the rod antenna moves.

### BACKGROUND OF THE INVENTION

1. Field of the Invention

The present invention relates to an antenna device of a wireless phone, and more particularly to an antenna device of a wireless phone, in which an antenna is rotated at a predetermined angle so as to minimize any effect of electronic waves when a user is using the phone.

2. Discussion of the Related Art

Generally, a personal wireless communication service unit such as a portable phone and a personal communication service (PCS) phone, and a cellular phone is used as portable communication means.

Since the personal wireless communication service unit transmits and receives a radio high frequency signal to and from a base station to perform communication, an antenna is essentially required in the inner part or the outer part of the personal wireless communication service unit to realize optimal transmission and reception of the signal.

For bi-directional communication of high quality, the antenna converts signals received from an electronic circuit provided in the personal wireless communication service unit into electronic waves to efficiently transmit the signals. Also, the antenna receives required electronic waves and converts them into signals to efficiently receive the signals.

The aforementioned antenna device of the conventional personal wireless communication service unit, as shown in FIGS. 1 and 2, has a combination structure of a built-in rod antenna 1 and an extendible helical antenna 2. The helical antenna 2 is threaded onto a fitting metal 4 fixed to a main body case 3 of the personal wireless communication service unit. The fitting metal 4 is electrically connected with an antenna contact terminal 5 connected with a circuit board (not shown) in the personal wireless communication service unit. A rod antenna guide 6 is provided in the main body case 3 at a lower part of the helical antenna 2. In a state where the helical antenna 2 is fixed to the case 3 as above, a user extends the built-in rod antenna 1 if necessary. The rod antenna 1 fails to function as an antenna in a state where it is built in the rod antenna guide 6. The rod antenna 1 functions as an antenna when it is completely extended toward the outside and its stopper 7 is in contact with the lower part of the fitting metal 4 in the helical antenna 2. The user can use a communication service with only the function of the helical antenna 2 in an area where a receiving signal is good. However, the user uses the communication service in an area where the receiving signal is weak by extending the rod antenna 1 to reinforce the function of the helical antenna.

In the aforementioned structure of the conventional wireless phone having the rod antenna 1 and the helical antenna 2 in combination, it is difficult to change the direction (angle) of the rod antenna 1 and the helical antenna 2. In other words, once the helical antenna 2 is fixed to the outer part of the wireless phone, the rod antenna 1 must move in a linear direction by passing through the helical antenna and the rod antenna guide 6. In this case, it is difficult to adjust angles of the rod antenna and the helical antenna.

A conventional structure of a wireless phone having only a helical antenna of which angle can be changed is disclosed in the Korean Utility Model Publication Number 2001-1465. However, it is apparent that this conventional structure could not be applied for the antenna structure of the present invention having both the helical antenna and the rod antenna.

In the aforementioned structure of the wireless phone having the helical antenna and the rod antenna, the antennas are fixed in parallel with the rod antenna guide 6, i.e., a main body 8 of the wireless phone. In this case, the electronic waves from the antennas are vertically irradiated against head and face of the user, thereby causing the user to be excessively exposed to the electronic waves.

The effect of the electronic waves will be described in more detail with reference to FIG. 1. A magnetic field is formed in an arrow direction of a dotted line around the central shaft of the rod antenna 1 and the helical antenna 2. An electric field is formed in parallel with the antennas. Actually, the magnetic field is more harmful to a human body than the electric field. If the user tries call by closely contacting her/his ear with a main body 9 of a receiving part, the magnetic field of the electronic waves from the antenna is radiated toward head of the user. That is, a structural problem arises in that the conventional wireless phone having the rod antenna and the helical antenna cannot help being exposed to the strong electronic waves.

### SUMMARY OF THE INVENTION

The present invention is directed to an antenna device of a wireless phone that substantially obviates one or more of the problems due to limitations and disadvantages of the related art.

An object of the present invention is to provide an antenna device of a wireless phone that can effectively adjust directions of a helical antenna and a rod antenna so as to minimize any effect of electronic waves when a user is using the phone.

Additional features and advantages of the invention will be set forth in the description which follows, and in part will be apparent from the description, or may be learned by practice of the invention. The objectives and other advantages of the invention will be realized and attained by the scheme particularly pointed out in the written description and claims hereof as well as the appended drawings.

To achieve these and other advantages and in accordance with the purpose of the present invention, as embodied and broadly described, an antenna device of a wireless phone according to the present invention is characterized in that a fitting metal is spaced apart from a contact part of a rod antenna guide at a predetermined distance or the rod antenna guide has an inner diameter enough to rotate the fitting metal at a predetermined angle. A connecting rod fixed to a main body case of the wireless phone is provided at both ends of the fitting metal fitted into a helical antenna, and the fitting metal is rotated at a predetermined angle with respect to the connecting rod.

In the present invention, the rod antenna guide is spaced apart from the end of the fitting metal at a predetermined distance to rotate the fitting metal fixed to the helical antenna at a predetermined angle. Meanwhile, if the inner diameter of the rod antenna guide is sufficiently greater than the outer diameter of the end of the fitting metal, the object of the present invention can be attained even if the end of the fitting metal and the end of the rod antenna guide are not spaced apart from each other. However, since there is limitation in increasing the inner diameter of the rod antenna guide due to the trend toward miniaturization of the wireless phone, it is desirable that the end of the fitting metal is spaced apart from the rod antenna guide to form a predetermined space.

Since the fitting metal has fluidity, it is connected with the antenna contact terminal by the connecting rod so as not to avoid short.

An angle adjustment guide groove is formed in the main body case of the wireless phone, which is in contact with the fitting metal, to limit angle adjustment of the helical antenna, and the angle adjustment distance of the helical antenna is selected depending on the position of guide tackles formed in the guide groove.

To further achieve these and other advantages and in accordance with the purpose of the present invention, an antenna device of a wireless phone according to the present invention is characterized in that a rod antenna and a helical antenna are constructed in such a manner that their angle is adjusted at a predetermined angle from a main body of the wireless phone when the inner end of the rod antenna is positioned at the end of the helical antenna by moving the rod antenna through the helical antenna.

The angle of the helical antenna and the rod antenna is adjusted along an angle adjustment guide groove formed in a main body case of the wireless phone.

The angle adjustment guide groove includes a plurality of guide tackles, and the angle adjustment position of the helical antenna and the rod antenna is selected depending on the position of the guide tackles.

The helical antenna includes an elastic protrusion at a side, the elastic protrusion being constructed to move along the guide adjustment guide groove.

The helical antenna is fixed to the main body case by a connecting rod and is rotated at a predetermined angle around the connecting rod.

The connecting rod is formed of a conductive material and acts to connect the helical antenna with an antenna contact terminal.

A fitting metal is provided between the helical antenna and the connecting rod, the fitting metal being threaded onto the helical antenna.

It is to be understood that both the foregoing general description and the following detailed description are exemplary and explanatory and are intended to provide further explanation of the invention as claimed.

### BRIEF DESCRIPTION OF THE ATTACHED DRAWINGS

The invention will be described in detail with reference to the following drawings in which like reference numerals refer to like elements wherein:

FIG. 1 is a perspective view of a conventional wireless phone illustrating a structure of a general antenna;

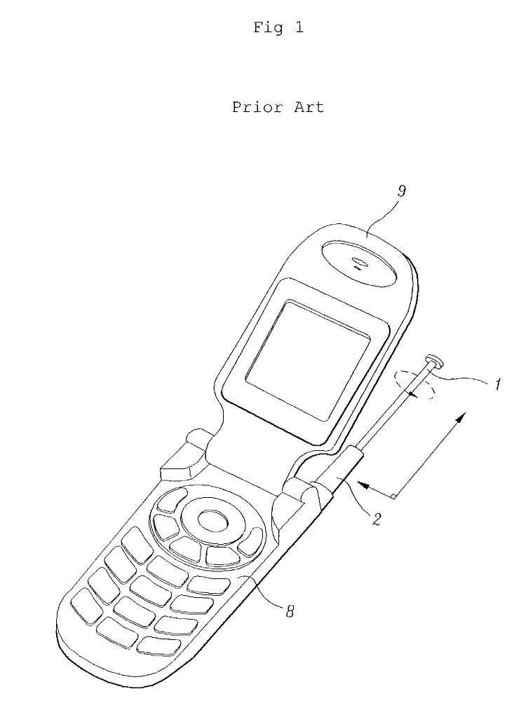

FIG. 2 is a sectional view of a conventional wireless phone illustrating a structure of a general antenna;

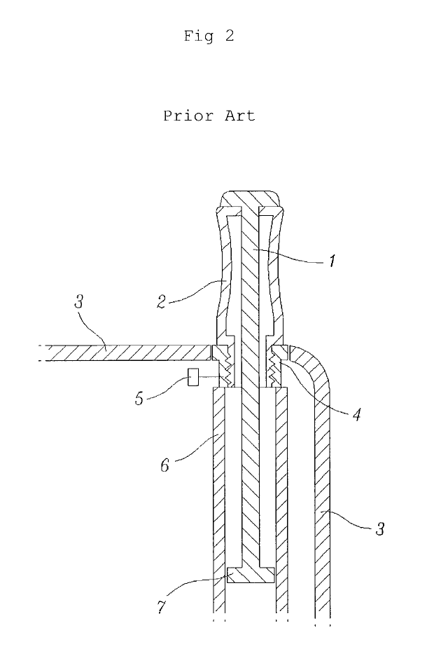

FIG. 3 is a perspective view of a wireless phone according to the present invention that can adjust an angle of an antenna;

FIG. 4 is a sectional view of a wireless phone according to the present invention that can adjust an angle of an antenna;

FIG. 5 illustrates a rotational state of an antenna of FIG. 4, which is rotated at a predetermined angle;

FIG. 6 illustrates a structure of an antenna of FIG. 4 additionally having a rotation stopper means; and

FIG. 7 illustrates an installation example of an angle adjustment guide groove of an antenna in a wireless phone case of an antenna connecting part.

### DETAILED DESCRIPTION OF THE PREFERRED EMBODIMENTS

Reference will now be made in detail to the preferred embodiments of the present invention, examples of which are illustrated in the accompanying drawings.

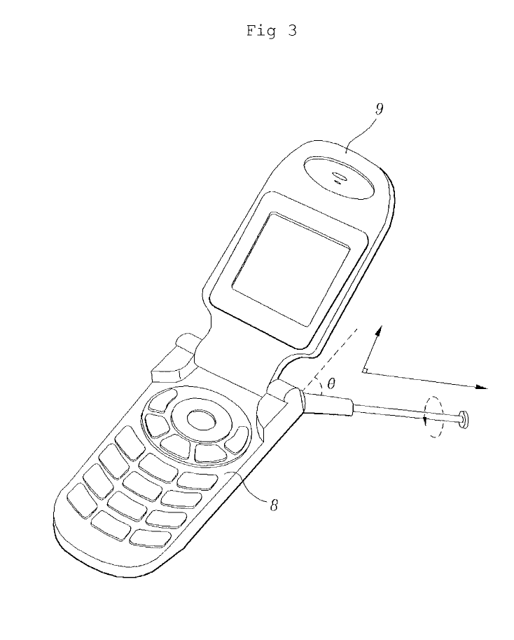

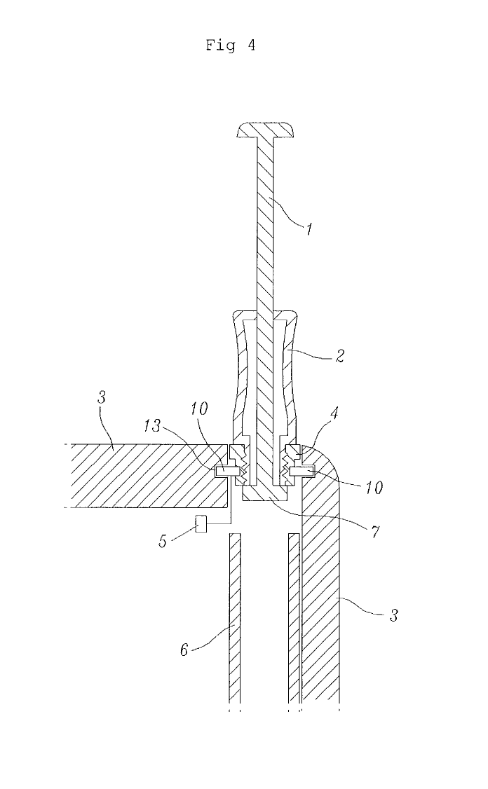

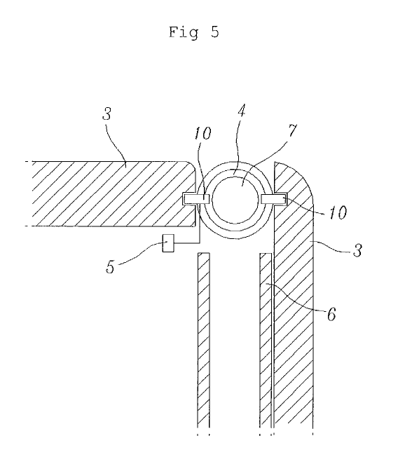

The construction and operation according to the present invention will be described with reference to FIGS. 3 to 7.

A built-in type rod antenna 1 has a structure that can extend to a position where a rod antenna stopper 7 of a wireless phone is stopped at an end of a helical antenna 2. The helical antenna 2 is threaded onto a fitting metal 4 of the helical antenna rotatably fixed to a main body case 3 of the wireless phone. The fitting metal 4 of the helical antenna 2 is fixed to the main body case 3 by a connecting rod 10 of a conductive metal. A groove 13 is formed in the fitting metal 4 to rotate the fitting metal 4 at a predetermined angle using the connecting rod as a shaft. In this case, an inner diameter of the groove 13 is greater than an outer diameter of the connecting rod 10. Meanwhile, a portion where the connecting rod 10 is fixed to the case 3 is firmly fixed so as not to move the connecting rod 10.

An antenna contact terminal 5 is connected with the connecting rod 10 so that the helical antenna 2 is electrically connected with the antenna contact terminal 5. If the antenna contact terminal is directly connected with the fitting metal 4, the contact portion is likely to cause short by means of stress due to fluidity of the fitting metal 4. Accordingly, the antenna contact terminal is not directly connected with the fitting metal 4.

Meanwhile, a stopper 7 of the rod antenna 1 is constructed to move along a rod antenna guide 6 built in the main body of the wireless phone. When the rod antenna is outwardly extended to a portion where the stopper 7 of the rod antenna 1 is in contact with the end of the fitting metal 4, the rod antenna 2 is connected with the antenna contact terminal 5 to perform an antenna function.

In a state where the rod antenna 2 is outwardly extended, if the rod antenna 1 and the helical antenna 2 are rotated at a predetermined angle θ, preferably 45°, as shown in FIG. 3, an angle is adjusted at θ (45°) against a main body 8 of the wireless phone and at 90° approximately against a main body 9 of a receiving part. If the main body 9 of the receiving part is positioned at 90° against the antenna, the magnetic field is generated from the antenna in parallel with the main body 9 of the receiving part. In this case, the user can be protected from electronic waves harmful to the human body even though the user uses the wireless phone by closely contacting an ear with the main body of the receiving part. Considering the electronic waves harmful to the human body, a structure may be devised in which the antenna is fixed to the main body of the receiving part at 90°. However, it is difficult for a current size of the wireless phone to ensure a space that can provide a rod antenna guide having a rod antenna.

Preferably, the end of the rod antenna guide 6 is spaced apart from the end of the fitting metal 4 at a predetermined distance so that the stopper 7 of the rod antenna is not caught in the rod antenna guide 6, thereby facilitating angle adjustment between the helical antenna 2 and the guide antenna 1.

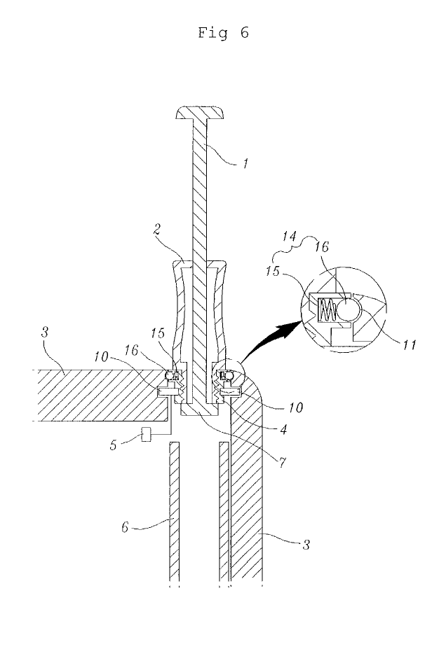

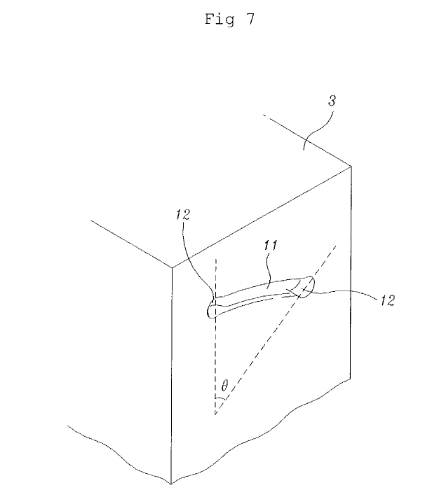

Furthermore, to facilitate angle adjustment in a predetermined position, as shown in FIGS. 6 and 7, an angle adjustment guide groove 11 is formed in a portion where the main body case 3 of the wireless phone is in contact with the fitting metal 4. A plurality of guide tackles 12 are formed in the angle adjustment guide groove 11. An elastic protrusion 14 having a spring 15 and a ball 16 is fixed to the fitting metal 4. The ball 16 of the elastic protrusion 14 is fitted into the angle adjustment guide groove 11. In this state, the rod antenna 1 is outwardly extended so that the stopper 7 of the rod antenna is in contact with the fitting metal 4. Afterwards, the helical antenna 2 is pushed so that the elastic protrusion 14 moves along the angle adjustment guide groove 11. The elastic protrusion 14 is then stopped as the ball 16 of the elastic protrusion 14 is caught in the depressed guide tackles 12.

If the antenna is pushed in an opposite direction to move the antenna to its original position, the elastic protrusion 14 moves and is stopped at the original guide tackle. In this state, the outwardly extended rod antenna 2 is pushed to the rod antenna guide 6.

As aforementioned, the antenna device of a wireless phone according to the present invention has the following advantages.

When the inner end of the rod antenna is positioned at the end of the helical antenna by moving the rod antenna through the helical antenna, the rod antenna and the helical antenna are constructed in such a manner that their angle is adjusted at a predetermined angle from the main body of the wireless phone. The angle of the helical antenna and the rod antenna is adjusted along the angle adjustment guide groove formed in the main body case of the wireless phone. This structure can protect the user of the wireless phone from the harmful electronic waves and adjust the direction of the antennas without damaging appearance of the wireless phone.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An antenna device of a wireless phone characterized in that a rod antenna and a helical antenna are constructed in such a manner that their angle is adjusted at a predetermined angle from a main body of the wireless phone when the inner end of the rod antenna is positioned at the end of the helical antenna by moving the rod antenna through the helical antenna.

2. The antenna device of a wireless phone according to claim 1, wherein the angle of the helical antenna and the rod antenna is adjusted along an angle adjustment guide groove formed in a main body case of the wireless phone.

3. The antenna device of a wireless phone according to claim 2, wherein the angle adjustment guide groove includes a plurality of guide tackles, and the angle adjustment position of the helical antenna and the rod antenna is selected depending on the position of the guide tackles.

4. The antenna device of a wireless phone according to claim 2 or 3, wherein the helical antenna includes an elastic protrusion at a side, the elastic protrusion being constructed to move along the guide adjustment guide groove.

5. The antenna device of a wireless phone according to claim 1 or 2, wherein the helical antenna is fixed to the main body case by a connecting rod and is rotated at a predetermined angle around the connecting rod.

6. The antenna device of a wireless phone according to claim 5, wherein the connecting rod is formed of a conductive material and acts to connect the helical antenna with an antenna contact terminal.

7. The antenna device of a wireless phone according to claim 6, further comprising a fitting metal provided between the helical antenna and the connecting rod, the fitting metal being threaded onto the helical antenna.

8. The antenna device of a wireless phone according to claim 1 or 2, further comprising a rod antenna guide provided at the lower part of the helical antenna to guide the rod antenna, the rod antenna guide being spaced apart from the end of the helical antenna at a predetermined distance.
